(19) United States
(12) Patent Application Publication
(10) Pub. No.: US 2007/0246069 A1
(43) Pub. Date: Oct. 25, 2007

(54) Method and apparatus for selectively releasing a rinse aid in a dishwasher

(75) Inventors: Robert A. Elick, Jackson, TN (US); Jonathan D. King, Cedar Grove, TN (US)

Correspondence Address: DIEDERIKS & WHITELAW, PLC, 12471 Dillingham Square, #301, Woodbridge, VA, 22192, US

(73) Assignee: Maytag Corp.

(21) Appl. No.: 11/407,116

(22) Filed: Apr. 20, 2006

(51) Int. Cl. B08B 7/04; B08B 9/20; B08B 3/00

(52) U.S. Cl. 134/18; 134/56 D; 134/58 D; 134/25.2; 134/34

(57) ABSTRACT

A dishwasher includes a system for conditionally releasing a rinse aid into a washing chamber. The dishwasher includes a dispenser for storing rinse aid, a sensor for detecting a temperature of washing fluid in the washing chamber and a controller operatively coupled to the sensor and the dispenser. The controller, based upon a signal received from the sensor indicating a temperature of the washing fluid, activates the dispenser to release the rinse aid. The controller is programmed to only release the rinse aid when the temperature is above a predetermined threshold value.

### BACKGROUND OF THE INVENTION

1. Field of the Invention

The present invention pertains to the art of dishwashers and, more particularly, to a dishwasher having a controller that selectively releases a rinse aid during a rinse cycle based on a temperature of washing fluid in the dishwasher.

2. Discussion of the Prior Art

The prior art is replete with dishwashers that employ various techniques to wash a wide range of kitchenware, such as dishes, pots, pans, glasses and the like. The dishwashers perform washing operations that typically employ a number of cycles to wash the kitchenware. In general, the number and type of cycles vary from manufacturer to manufacturer. In addition to standard cycles, e.g., wash, rinse and dry, often times, a dishwasher will have “special” cycles that address particular wash conditions, e.g., heavy soil, light soil, pot scrubber etc. In any event, the cycles are generally divided into steps, each having a particular duration. However, while the number and duration of steps will vary from appliance to appliance, there are certain steps that occur in every washing operation. That is, every washing operation has at least one washing step, during which water is mixed with detergent and directed onto kitchenware to wash away soil, and at least one rinsing step, during which clean water is sprayed onto the kitchenware to remove remaining soil and/or detergent.

As indicated above, during the washing step, detergent is mixed with water to form a washing fluid. The detergent can simply be placed within the dishwasher and exposed to sprays or jets of water or, alternatively, released from a dispenser. The release of detergent is typically based upon time. That is, at some point after initiation of the washing step, a controller executes a timed release of detergent from the dispenser.

During the rinsing step, clean water is sprayed onto the kitchenware to wash away any remaining soil and/or washing fluid. Actually, depending on the particular dishwasher, the washing operation may include multiple rinse steps to ensure that all the soil and/or washing fluid is washed away, leaving behind sparkling clean dishes. Following the rinse step, the washing operation enters a drying phase or step where the dishes are allowed to dry, either by the passage of time, or through the introduction of heat into the dishwasher. Unfortunately, after the drying phase, water spots often times remain on the kitchenware. While particularly noticeable on glassware, the water spots can also be present on other kitchenware, such as plates, silverware and the like.

In order to reduce water spots, many consumers add a rinse aid that is released during one of the rinse steps. In some cases, the rinse aid can be in the form of a tablet that is supported from a dishrack in the dishwasher. However, in most cases, the rinse aid is in the form of a liquid released from a dispenser. That is, at some point during the rinse step, a controller will automatically release the rinse aid from the dispenser. More specifically, as long as there is rinse aid in the dispenser, the controller will release the rinse aid into the washing chamber at a predetermined time during the rinse step. The rinse aid then mixes with the water and is sprayed into the kitchenware in order to reduce spotting. However, adding rinse aid at an inappropriate point can result in improper mixing of the water and rinse aid.

Based on the above, there exists a need in the art for a dishwasher including a controller that releases rinse aid only at an appropriate point of a rinse cycle. More specifically, there exists a need in the art for a dishwasher that can sense a temperature of washing fluid and release rinse aid at a point in the rinse cycle at which proper mixing of rinse aid and washing fluid will occur.

### SUMMARY OF THE INVENTION

The present invention is directed to a dishwasher having a system for conditionally releasing a rinse aid into a washing chamber. In accordance with the invention, the dishwasher includes a dispenser for storing rinse aid, a sensor for detecting a temperature of water or washing fluid in the washing chamber and a controller operatively coupled to the sensor and the dispenser. The controller, based upon a signal received from the sensor indicating a temperature of the washing fluid, activates the dispenser to release the rinse aid. The controller is programmed to only release the rinse aid when the temperature of the washing fluid is above a predetermined threshold value. That is, the controller will only release the rinse aid if the temperature of the washing fluid is above a cloud point of the rinse aid such that foaming will not occur upon mixing of the rinse aid with the washing fluid.

Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWING

FIG. 1 is an upper right, perspective view of a dishwasher incorporating a rinse aid dispensing system constructed in accordance with the present invention, with a door of the dishwasher being in an open position.

### DETAILED DESCRIPTION OF THE PREFERRED EMBODIMENT

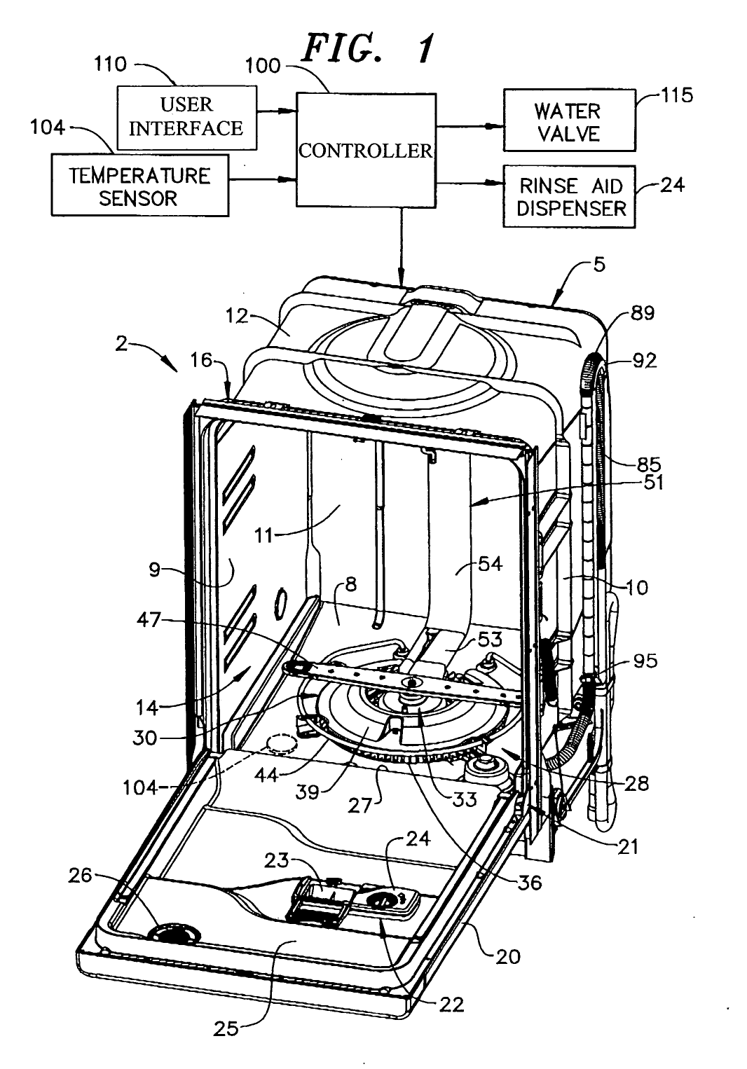

With reference to FIG. 1, a dishwasher constructed in accordance with the present invention is generally indicated at 2. As shown, dishwasher 2 includes a tub 5 which is preferably injection molded of plastic or formed from stainless steel so as to include integral bottom, side, rear and top walls 8-12 respectively. Within the confines of walls 8-12, tub 5 defines a washing chamber 14 within which soiled kitchenware is adapted to be placed upon shiftable upper and lower racks (not shown). Tub 5 has attached thereto a frontal frame 16 which pivotally supports a door 20 used to seal washing chamber 14 during a washing operation. As shown, door 20 is pivotally supported to frame 16 at a bottom portion 21. In connection with the washing operation, door 20 is preferably provided with a detergent tray assembly 22 including a detergent dispenser 23 within which a consumer can place liquid, particulate or tabular washing detergent for dispensing at a predetermined portion of a washing operation. In addition, in a manner that will be discussed more fully below, detergent tray assembly 22 also includes a rinse aid dispenser 24 for releasing a rinse aid during another predetermined portion of the washing operation. In any case, door 20 is provided with a liner 25 within which is arranged detergent tray assembly 22, as well as a vent 26 that allows hot air to escape from washing chamber 14 following a drying operation. Liner 25 also includes a lower lip portion 27 that extends across bottom portion 21 of door 20.

Disposed within tub 5 and, more specifically, mounted within a central opening (not shown) in a sump portion 28 of tub 5 is a pump assembly 30. In the embodiment shown, pump assembly 30 includes a main housing 33, an annular, radially outermost strainer 36 and a filter guard 39. Extending about a substantial portion of pump assembly 30, at a portion raised above bottom wall 8, is a heating element 44. In a manner known in the art, heating element 44 preferably takes the form of a sheathed, electric resistance-type heating element. A detailed description of the exact structure and operation of pump assembly 30 does not form part of the present invention and thus will not be described more fully herein. Instead, various known pump arrangements can be employed, such as that disclosed in U.S. Pat. No. 6,997,193 which is incorporated herein by reference.

In general, pump assembly 30 is adapted to direct washing fluid to at least a lower wash arm 47 and a conduit 51. As depicted, conduit 51 includes a substantially horizontal lower section 53 extending away from main housing 33 of pump assembly 30, a vertical section 54, which generally extends along rear wall 11, and a generally horizontally extending upper portion (not shown) which leads to an upper wash arm (also not shown). Vertical section 54 has attached thereto a wash fluid diverter (not shown) that engages with a rack mounted wash arm (also not shown). In any case, pump assembly 30 is designed to establish a controlled flow of washing fluid that is sprayed upon kitchenware supported within washing chamber 14 during the washing operation.

At the completion of the washing operation, pump assembly 30 guides the washing fluid through a drain pump (not shown) having associated therewith a drain hose 85 including at least one corrugated or otherwise curved portion 89 that extends about an arcuate hanger 92 provided on an outside surface of side wall 10. Drain hose 85 is also preferably secured to tub 5 through various clips, such as that indicated at 95. In any event, in this manner, an upper loop is maintained in drain hose 85 to ensure proper drainage in a manner known in the art.

In accordance with the invention, dishwasher 2 includes a controller 100 that is operatively connected to rinse aid dispenser 24. Controller 100 is also operatively connected to a temperature sensor 104 which is preferably mounted within sump portion 28 of washing chamber 14. Temperature sensor 104 is positioned so as to detect and signal a temperature of washing fluid circulating within washing chamber 14. In accordance with the invention, controller 100 will only activate rinse aid dispenser 24, releasing rinse aid into washing chamber 14, when a temperature of the washing fluid is at or above a predetermined temperature value. Most preferably, controller 100 will only activate rinse aid dispenser 24 when the temperature of the washing fluid, as sensed by temperature sensor 104, is above approximately 125° F. (51.7° C.). That is, rinse aid will only be released when the temperature of the washing fluid is above a cloud point of the rinse aid as will be discussed more fully below.

After loading kitchenware into washing chamber 14, detergent into detergent dispenser 23 and rinse aid into rinse aid dispenser 24, a consumer initiates a washing operation in a manner known in the art through user interface 110. Initially, water is introduced into tub 5 upon opening of a water valve 115, with the water being sprayed about washing chamber 14 by, for example, wash arm 47 to perform an initial dishware cleansing operation. After a predetermined time period, dishwasher 2 enters a washing step at which point detergent dispenser 23 is opened, releasing detergent into washing chamber 14 to mix with the water to form a washing fluid. In some instances, the water is heated by heating element 44 prior to the introduction of detergent. In any event, the washing fluid enters pump assembly 30 and is sprayed about washing chamber 14 onto the kitchenware. Often times, periodic partial drain steps are initiated to remove soil accumulating in the washing fluid. That is, depending upon a level of soil in the washing fluid, as sensed by, for example, a turbidity sensor (not shown), some portion of the washing fluid is directed through drain hose 85 and onward to a household drain and additional fresh water is introduced into washing chamber 14.

At the completion of the washing step, all of the washing fluid is drained from washing chamber 14 and a rinse step is initiated during which water which forms a fresh washing or rinse fluid is released into washing chamber 14. Once a sufficient amount of rinse fluid is in washing chamber 14, pump assembly 30 is activated and the rinse fluid is sprayed through, for example, wash arm 47, onto the kitchenware. As the rinse fluid circulates throughout the system, heating element 44 is activated to raise the temperature of the rinse fluid. In accordance with the invention, at a predetermined point in the cycle, controller 100 checks to make sure the water temperature exceeds a predetermined threshold temperature, e.g., approximately 125° F. (51.7° C.) as determined by sensor 104. If not, rinse aid is not dispensed. That is, controller 100 will only release rinse aid when the temperature of the rinse fluid is sufficiently above the cloud point of the rinse aid. More specifically, if, for whatever reason, the temperature of the rinse fluid does not reach the predetermined temperature, controller 100 will not release rinse aid, even though dispenser 24 is full. In this manner, controller 100 ensures that rinse aid dispenser 24 is not activated to release a rinse aid if the temperature of the washing fluid is below the predetermined temperature. Accordingly, upon releasing the rinse aid into the washing fluid, controller 100 ensures that the rinse aid will not foam which could create excessive noise or create cavitations that could be detrimental to pump assembly 30.

At this point, it should be readily understood that the present invention ensures that rinse aid is only dispensed when the temperature of the washing fluid is of a sufficient level such that the rinse aid properly mixes with the washing fluid to ensure adequate dispersion within the wash system and eliminate any negative effects that could be associated with foaming of the rinse aid upon mixing with a washing fluid having too low of a temperature. In this manner, the present invention aids in having dishwasher 2 operate quietly and, ultimately, prolongs an overall service life of pump assembly 30.

Although described with reference to a preferred embodiment of the invention, it should be readily understood that various changes and/or modifications can be made to the invention without departing from the spirit thereof. For instance, while shown in connection with a conventional dishwasher, the present invention could be readily incorporated into other dishwashers such as, for example, drawer-type dishwashers. Also, the particular type and style of the rinse aid dispenser employed in connection with the present invention can readily vary. In general, the invention is only intended to be limited by the scope of the following claims.

I/we claim:

1. A dishwasher comprising:
a tub having at least bottom, rear and opposing side walls that define a washing chamber, said washing chamber being adapted to be sealed for a washing operation;
a dispenser for selectively releasing a rinse aid into the washing chamber during a washing operation;
a sensor for detecting a temperature of washing fluid provided in the washing chamber for the washing operation; and
a controller operatively coupled to the sensor and the dispenser, said controller receiving a washing fluid temperature signal from the sensor and, based upon a temperature of the washing fluid, activates the dispenser to release the rinse aid wherein, said controller activates the dispenser only when the temperature of the washing fluid is above a predetermined temperature.

2. The dishwasher according to claim 1, wherein the temperature sensor is mounted in a sump portion of the washing chamber.

3. The dishwasher according to claim 1, wherein the predetermined temperature is approximately 125° F. (51.7° C.).

4. A dishwasher comprising:
a tub having at least bottom, rear and opposing side walls that define a washing chamber, said washing chamber being adapted to be sealed for a washing operation;
a dispenser for selectively releasing a rinse aid into the washing chamber during a washing operation;
sensing means for detecting a temperature of washing fluid provided in the washing chamber for the washing operation; and
means for releasing the rinse aid, said releasing means receiving a washing fluid temperature signal from the sensing means and, based upon a temperature of the washing fluid, activates the dispenser to release the rinse aid wherein, said releasing means activates the dispenser only when the temperature of the washing fluid is above a predetermined temperature.

5. The dishwasher according to claim 4, wherein the temperature sensor is mounted in a sump portion of the washing chamber.

6. The dishwasher according to claim 4, wherein the predetermined temperature is approximately 125° F. (51.7° C.).

7. A method of performing a washing operation in a dishwasher comprising:
initiating a washing operation in a washing chamber of a dishwasher;
introducing a washing fluid into the washing chamber for a washing phase;
releasing detergent into the washing chamber to mix with the washing fluid during the washing phase;
spraying jets of washing fluid about the washing chamber;
initiating a drain step of the washing operation;
introducing a secondary washing fluid into the washing chamber for a rinse phase;
sensing a temperature of the secondary washing fluid;
activating a rinse aid dispenser to release a rinse aid into the washing chamber only if the temperature of the secondary washing fluid during the rinse phase is above a predetermined temperature.

8. The method of claim 7, wherein the rinse aid is only released if the predetermined temperature is at least approximately 125° F. (51.7° C.).
